(19) United States
(12) Patent Application Publication
(10) Pub. No.: US 2007/0163720 A1
(43) Pub. Date: Jul. 19, 2007

(54) Top press plate of aluminum extrude and its clamp assembly for folder gluer

(75) Inventor: Shing-Tsai Chiang, Tu Cheng City (TW)

Correspondence Address: TROXELL LAW OFFICE PLLC, SUITE 1404, 5205 LEESBURG PIKE, FALLS CHURCH, VA, 22041, US

(73) Assignee: TSAIR SHUENN Machinery Ind., Co., Ltd.

(21) Appl. No.: 11/296,497

(22) Filed: Dec. 8, 2005

(51) Int. Cl. B32B 37/00

(52) U.S. Cl. 156/580

(57) ABSTRACT

The invention is related to a top press plate and clamp assembly for folder gluer It is mainly to improve the aluminum extrude structure for the top press plate by redesigning to accommodate more than one clamp and functional components. The invention is able to handle troubleshooting for any situation in a paper box making process. Especially, the aluminum extrude is in uniform dimensions with clamp that is easy for assembly and disassembly. It saves efforts and time for operators. Besides, the clamp and functional components also facilitate the integrated automated paper making process by troubleshooting any possible problem. Therefore, overall quality and operation efficiency is greatly improved. The operators also can make timely adjustment and corrections to achieve the desired goals and improve economical benefits significantly.

### BACKGROUND OF THE INVENTION

1. Field of the Invention

The invention is related to a top press plate for folder gluer, especially, an improved top press plate of aluminum extrude with specific clamp that can be fast assembled and disassembled to increase quality and efficiency for box manufacturing.

2. Description of the Prior Art

For a common folder gluer, the plates on both sides of the conveyor have a stop with the top press plate of aluminum extrude. The stop is fixed onto the plate through screws at its bottom, while a hollow joint at its top accommodates more than one clamp at a designated position. In a practical operation, extra functional components such as C base, lifter, strip and stopper etc. are provided to achieve integrated automation for paper box forming.

Nevertheless, the aluminum extrude does not have the desirable design in the joint for connection and fixation with the clamp. The joint is hollow, so the clamp has to enter from one end to a predetermined position. Thus, before the preparatory work for gluer operation, the number of clamps needs to be confirmed. Besides, each clamp needs to be placed at the designated position for fixation purpose. This is extremely inconvenient when paper jam occurs in the conveyor and extra clamps and functional components are needed. Further, the existing aluminum extrude does not match the joint in size. It has to manufacture a variety of clamps. Therefore, the clamps at different positions on the aluminum extrude have different structure and size. They may create hassles and inconvenience for operators because they are not interchangeable. It is needless to say that they are economical.

In view, of this, the inventor for the invention with many years of experience in the design and manufacturing for folder gluer has made a thorough improvement on the above-mentioned shortcoming and developed a top press plate of aluminum extrude and its clamp assembly for folder gluer. It is expected to significantly benefit the industry.

### SUMMARY OF THE INVENTION

The main objective for the present invention is to provide a top press plate of aluminum extrude and its clamp assembly for folder gluer. The aluminum extrude for the top press plate is made in rectangle with constant dimensions, so it can accommodate more than one clamp and functional component to facilitate paper box manufacturing. Particularly, it is simple and fast for clamp to assemble and disassemble. For operators, it saves time and efforts. On the other hand, the clamp can work with all kinds of functional components to overcome issues in an integrated box manufacturing process. In this way, it improves the overall paper box product quality and operation efficiency. The operators, are able to make immediate adjustment and correction to achieve the desirable goal and greatly improve economic benefits.

The objectives, features and benefits for the present invention can be further demonstrated through the following preferred embodiment with graphic illustration.

### BRIEF DESCRIPTION OF THE DRAWINGS

Specific Drawing:

(1) The designated diagram for the present invention is FIG. 1.

(2) The legends for the components are as follows:

| | | | |
|---|---|---|---|
| folder gluer | (1) | fixation slider | (10) |
| bottom transmission | (11) | belt roller | (12) |
| belt plate | | | |
| top press plate | (13) | C frame | (14) |
| lifter slider | (15) | lifter | (16) |
| lifting handle | (162) | lifting rod | (163) |
| Clamp | (20) | aluminum extrude fixture | (21) |
| aluminum extrude fastener | (22) | screw | (23) |

FIG. 1 is the front view for a preferred embodiment for the folder gluer in the present invention.

FIG. 2 is local structure diagram for the folder gluer in the present invention.

FIG. 3 is another structural diagram for a preferred embodiment for the folder gluer in the present invention.

FIG. 4 is an illustration (1) for adjusting the top press plate for a preferred embodiment for the folder gluer in the present invention.

FIG. 5 is another illustration (2) for adjusting the top press plate for a preferred embodiment for the folder gluer in the present invention.

### DESCRIPTION OF MAIN COMPONENTS

| | | | |
|---|---|---|---|
| folder gluer | (1) | Fixation slider | (10) |
| bottom transmission | (11) | belt roller | (12) |
| belt plate | | | |
| bottom transmission belt | (121) | top press plate | (13) |
| aluminum extrude | (131) | top transmission belt | (132) |
| C frame | (14) | lifter slider | (15) |
| Lifter | (16) | fixation frame | (161) |
| lifting handle | (162) | lifting rod | (163) |
| Clamp | (20) | aluminum extrude fixture | (21) |
| connecting hole | (211) | extension | (212) |
| aluminum extrude fastener | (22) | screw | (23) |

### Detailed Description of the Preferred Embodiment

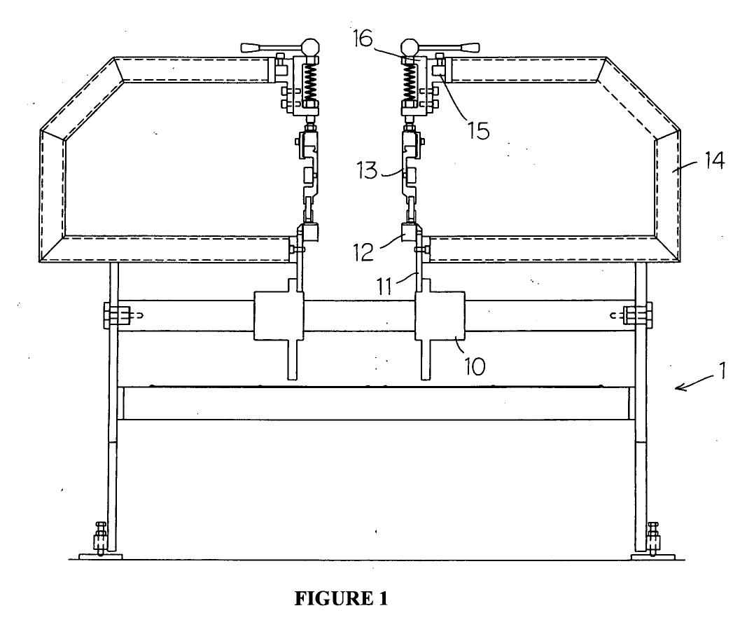

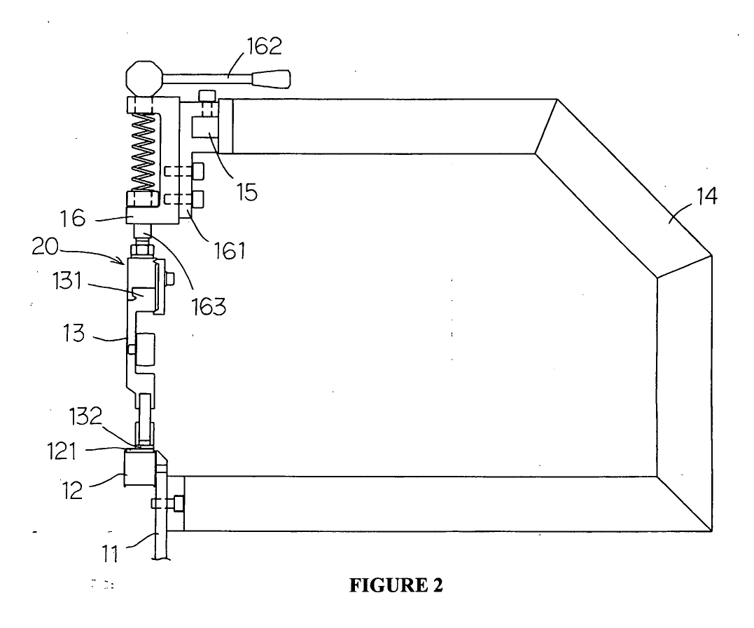

Please refer to FIG. 1 and FIG. 2 for the top press plate of aluminum extrude and its clamp assembly for folder gluer in the present invention. The gluer (1) has a left fixation slider and a right fixation slider (10). From the top, there are a bottom transmission belt plate (11) and a belt roller (12) for the bottom transmission belt (121). On the surface of the belt roller (12), there exist an aluminum extrude (131) on the top and a top press plate (13) for the top transmission belt (132). In this way, the top press plate (13) can shift onto the belt roller (12). At a proper location of the transmission belt plate (11), there is a C frame (14). On the other side of the C frame (14), there is a lifter slider (15) to accommodate a lifter (16) on the fixation frame (161). The lifter (16) has a lifting handle (162) and a lifting rod (163), so the lifting rod (163) can integrate with the top press plate (13) through the clamp (20) made of aluminum extrude fixture (21) and aluminum extrude fastener (22). It is through adjusting the lifting handle (162) to control the separation between the top press plate (13) and the bottom transmission belt (121) for fine-tuning the top press plate (13).

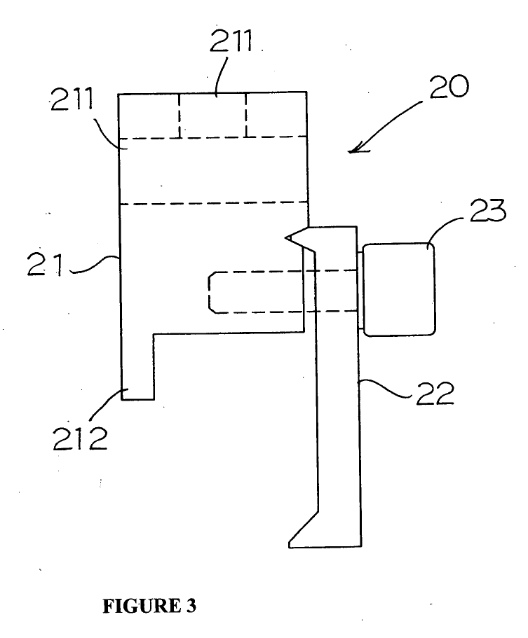

The aluminum extrudes (131) above the above-mentioned top press plate (13) adopts constant and uniform dimensional specifications that fit with the machine bas. In a practical operation, the aluminum extrude (131) provides more than one clamp (20). The clamp (20) is only to work with the lifter. On the other hand, the clamp (20) can be easily connected or removed at any place of the machine base where it fits. As shown in FIG. 3, it has different local structure than the clamp (20) for the above-mentioned lifter. However, its basic structure is similar and includes an aluminum extrude fixture (21) and an aluminum extrude fastener (22) connected through a screw (23). Especially, the aluminum extrude fixture (21) can accommodate a vertical or horizontal connecting hole (211) and an extension (212) separately or together. The end of the extension (212) may be in hook shape if needed for the assembly to stabilize the connection. Further, the vertical or horizontal connecting hole (211) is provided for connection of functional components like clamp, aluminum block, strip and stopper, to facilitate the box forming process.

The above description is for the structural features of the present invention. A practical operation would be like : in an integrated automated process for paper box, semi-finished product is fed from the front of the machine and runs fast between the left and the right fixation sliders (10). Through the top and bottom transmission belts (132 121), the semi-finished product moves forward stepwise through folding, gluing, squeezing, pressing and forming. If wrinkling, edge lifting, rough conveying, declining and paper jam happen, operators can install more than one clamp (20) on the aluminum extrude (131) for the top press plate (13) (at the location that malfunction occurs). Operators can also use appropriate functional components (such as clamp, aluminum block, strip, stopper and lifter etc.) to fix the problem and reduce the defect rate while increasing yield and efficiency.

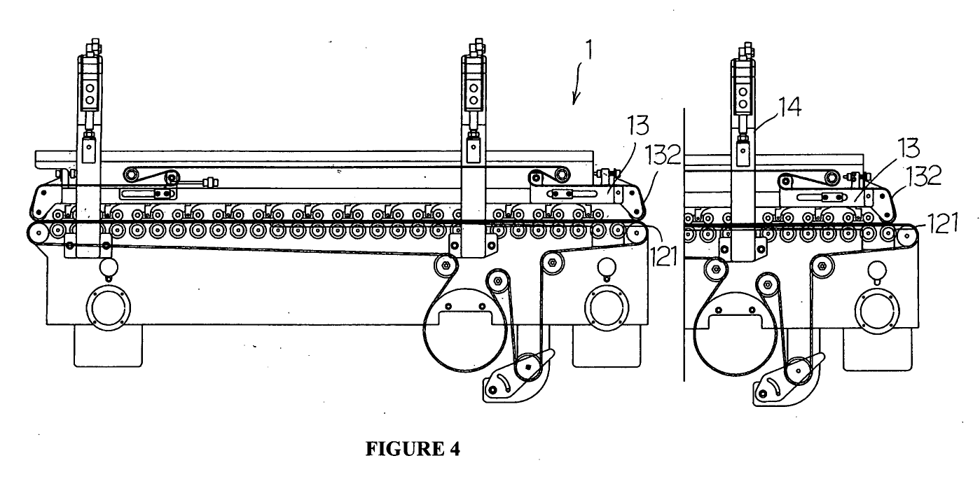

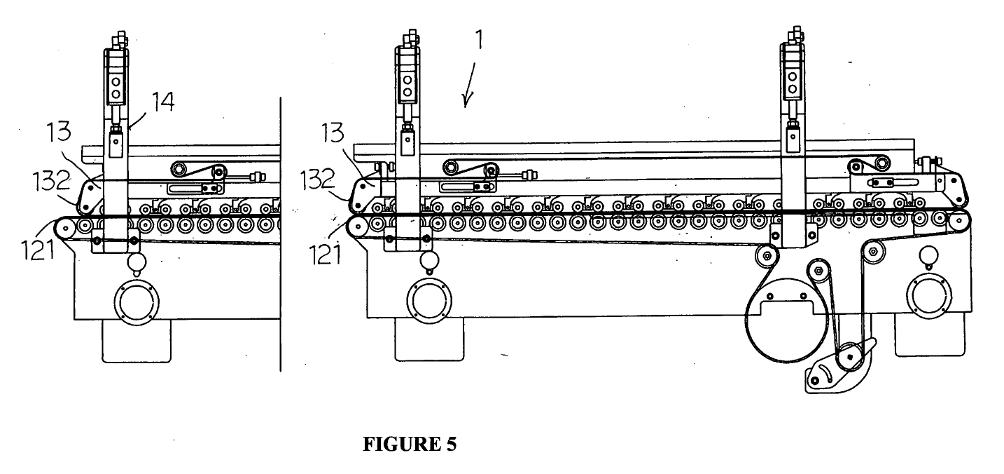

As shown in FIG. 4 and FIG. 5, in a practical operation, operators can timely adjust the top press plate (13) (forward or backward) to meet the forming requirements for different types of paper boxes. This will create more workspace and flexibility to facilitate the paper forming process.

The top press plate and clamp assembly for folder gluer in the present invention unifies the structure of aluminum extrude with the similar component in the machine base in uniform dimensional specifications, so more than one clamp or functional component can be used to facilitate the process and minimize downtime. More importantly, its fast and easy assembly and disassembly does not trouble the operators at all. On the other hand, the unique design for the clamp and functional components can help troubleshoot for an integrated automated box making process with overall quality and efficiency. Besides, operators can timely make adjustment and correction to achieve the desired goals and greatly improve economic benefits.

In summary, it is hoped the examination committee has a thorough understanding of the present invention for a top press plate and clamp assembly for folder gluer. The invention can achieve the expected objectives and benefits without being released to public yet, so it shall meet the requirements for innovation, practical usability and advancement. Accordingly, a patent application is filed.

The above description is only for a preferred embodiment for the present invention. Any modification and adjustment by people familiar with the skills in the field creating the equivalent benefits shall be covered within the claims by the inventor.

What is claimed is:

1. A top press plate for folder gluer, which has a left fixation slider and a right fixation slider, a bottom transmission belt plate on the top and a belt roller for the bottom transmission belt; the surface of the bottom transmission belt roller features in:
an aluminum extrude exists above and a top and a bottom transmission belts exist below while the aluminum extrude is in uniform dimensions and provided to accommodate more than one clamp.

2. A clamp suitable for the aluminum extrude for the top press plate for folder gluer in claim 1 includes an aluminum extrude fixture and an aluminum fastener connected by screw.

3. As described in claim 2 for a clamp, the aluminum extrude fixture can accommodate various functional components through vertical or horizontal connecting hole.

4. As described in claim 2 for a clamp, on one side of the aluminum fixture there exists an extension with end in hook shape.

5. As described in claim 2 for aluminum extrudes for a top press belt, there is a C frame at a proper location of the bottom transmission belt plate; on the other side of the C frame, there is a lifter slider to accommodate a lifter on the fixation frame; the lifter has a lifting handle and a lifting rod, so the lifting rod can integrate with the top press plate through the clamp made of aluminum extrude fixture and aluminum extrude fastener; it is through adjusting the lifting handle to control the separation between the top press plate and the bottom transmission belt for fine-tuning the top press plate.
